(19) United States
(12) Patent Application Publication
(10) Pub. No.: US 2024/0091793 A1
(43) Pub. Date: Mar. 21, 2024

(54) VORTEX INLET WITH CURVED GROOVED PLATE

(71) Applicant: TruGrit Energy Solutions, LLC, Monahans, TX (US)

(72) Inventor: James L. Cain, Odessa, TX (US)

(21) Appl. No.: 17/948,700

(22) Filed: Sep. 20, 2022

(51) Int. Cl. B04C 3/06; B01D 21/26; B04C 5/04; B04C 5/103

(52) U.S. Cl. CPC B04C 3/06; B01D 21/265; B04C 5/04; B04C 5/103

(57) ABSTRACT

The grit removal efficiency of a hydrocyclone desander is greatly improved by providing a curved plate within the separation chamber, positioned along one side of the chamber such that the incoming fluid stream is directed toward the concave surface of the curved plate. The curvature of the plate is a circular arc, preferably about a quarter circle. The trailing edge of the curved plate forms a 90° drop-off in the fluid flow which introduces an eddy region along the trailing edge. This eddy region contains a stagnant pressure zone, allowing particles to more easily drop out of the higher velocity inlet flow profile, further enhancing removal of the sand via the vortex dynamic. The plate can have grooves with a helical pitch inclined toward the accumulation end of the desander which help further channel the fluid flow and increase vortex velocity.

### BACKGROUND OF THE INVENTION

### Field of the Invention

The present invention generally relates to separation of substances in a fluid, and more particularly to an apparatus for separating solid particles from a liquid stream such as removing sand during oil well extraction.

### Description of the Related Art

Fluid processing is an important part of both oil well drilling and well production. Various fluids (“mud”) can be injected into a well during the drilling process to assist the drill head with lubrication and cooling, and to help remove rock cuttings. Other fluids can be injected for post-drilling operations such as fracking. Fracking is the injection of a fluid at high pressure into an underground rock formation to open fissures and allow trapped gas or crude oil to flow through the well to a wellhead at the surface.

It is often necessary to separate out components of oil field fluids for various reasons, particularly removing solid matter. Drilling fluids can be returned to the surface and recycled but the cuttings need to be removed. Fracking can introduce sand or other particles into the production stream (i.e., the oil to be extracted) and this sand needs to be removed before the crude oil can be further processed. Different types of devices are used depending on the particle sizes and other factors. Solids can range in size from less than two microns to several hundred microns: smaller than 2 microns are classified as clay, 2 to 74 microns is silt, 74 to 500 microns is sand, and particles larger than 500 microns are cuttings. Several types of separation devices have been developed including shakers, screen separators, centrifuges, desanders, desilters, filtration units, etc.

One common desander is known as a hydrocyclone and runs on a vortex principle. The fluid stream is injected into a long vertically-disposed tube or inlet pipe with a cylindrical or conical interior such that the fluid forms a whirlpool. This centrifugal movement pushes the heavier solids outward and downward along the inside wall of the separation chamber, where they can exit through a sand outlet at the bottom. Production fluid (mostly free of sand) exits at the top through a centrally located port, or outlet pipe.

### SUMMARY OF THE INVENTION

The present invention in at least one embodiment is generally directed to a vortex apparatus for separating solid particles from a fluid stream such as that used in desanding, comprising an elongate hollow body having a first and second ends, an inlet proximate the first end of the hollow body for receiving the fluid stream in an inlet direction generally perpendicular to a length direction of the hollow body and positioned to direct the fluid stream along one side of the interior of the hollow body, and a curved plate affixed to an inner surface of the hollow body proximate the first end and positioned along the one side of the interior such that the fluid stream is directed from the inlet toward a concave surface of the curved plate. The vortex apparatus can further include a first outlet proximate the first end of the hollow body with an entry port which extends into a circumferential central area of the interior, and a second outlet at the second end of the hollow body for removing a buildup of the solid particles. In the exemplary implementation the curved plate has a circular arc in a range of 30° to 120° and the concave surface has a plurality of grooves formed therein with a helical slant of approximately 14.5°. The curved plate has a leading edge and a trailing edge, and the inlet preferably includes a pipe section extending into the interior of the hollow body, the pipe section having an exit point immediately adjacent and on the same plane as the leading edge of the curved plate. The trailing edge of the curved plate creates a drop-off in the fluid flow providing an eddy region that contains a stagnant pressure zone, allowing particles to more efficiently drop out of the higher velocity inlet flow profile.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a front elevational view of a hydrocyclone desander in accordance with one implementation of the present invention;

FIG. 2 is a left side elevational view of the hydrocyclone desander of FIG. 1;

FIG. 3 is a close-up view of the top portion of the hydrocyclone desander as seen in FIG. 1 illustrating certain interior features including a curved grooved plate positioned to deflect the fluid stream coming from an inlet in accordance with one implementation of the present invention;

FIG. 4 is a perspective view of the curved grooved plate of FIG. 3;

FIG. 5 is a top sectional view taken along line V-V of FIG. 3 illustrating fluid flow around the curved grooved plate in accordance with one implementation of the present invention; and

FIG. 6 is a side sectional view taken along line VI-VI of FIG. 5 depicting relative sand density of the well fluid proximate the curved grooved plate.

The use of the same reference symbols in different drawings indicates similar or identical items.

### DESCRIPTION OF THE PREFERRED EMBODIMENT(S)

For applications with oil well fluids, it is critical to provide an optimum method for separating out solids from the particular fluid at hand, using devices such as desanders. There is other fluid processing equipment downstream from the desander that can suffer solids overload and plugging if the fluid exiting the desander has too high of a solids content. These problems can lead to downtime and costly repairs. While the centrifugal action of hydrocyclones is fairly effective at pushing the particles against the interior wall, the fluid flow is still turbulent (nonlinear) and a significant amount of sand can remain suspended near the central area of the vortex where the outlet port is positioned.

It would, therefore, be desirable to devise a separator having improved grit removal efficiency, particularly at high flow rates for initial high pressure production flow profiles. However, after the flow profile decreases into a normal pressure operating state, current desander technology begins to decrease in performance, so it would also be desirable to achieve a very high rate of solids removal during low pressure and low flow rate profiles.

It would be further advantageous if the feature of the desander imparting the improved grit removal efficiency could also guard against premature wear failure of the interior of the hydrocyclone. These and other advantages are achieved in various embodiments of the present invention using a hydrocyclone having a curved plate affixed to the interior of the hydrocyclone, positioned to deflect the incoming fluid stream. The curved plate creates a drop-off in the fluid flow providing an eddy region that contains a stagnant pressure zone, allowing particles to drop out of the higher velocity inlet flow profile. In the exemplary embodiment the curved plate has a generally circular arc, preferably about a quarter circle, and has helical grooves formed therein which help further direct the fluid flow and train the vortex in creating a more favorable high velocity cyclone in a shorter section of the vessel, allowing the heavier gravity particles to drop out sooner while maintaining a deeper vortex for those lesser gravity particles to exit the vortex.

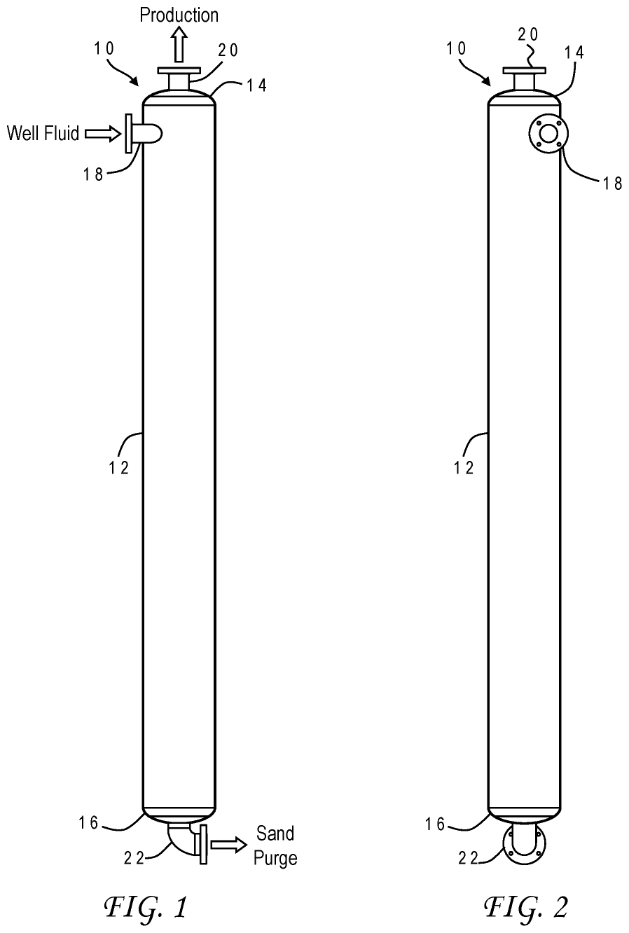

With reference now to the figures, and in particular with reference to FIGS. 1 and 2, there is depicted one embodiment 10 of a hydrocyclone desander constructed in accordance with the present invention. Desander 10 is generally comprised of a hollow main body 12, an upper outlet cover 14 attached via welding to the top of main body 10, and a lower outlet cover 16 attached via welding to the bottom of main body 12. Main body 12 has an interior space forming a separation chamber, and has an inlet 18 formed therein or attached thereto, via welding, proximate the upper portion of main body 12 for receiving the well fluid (crude oil) from the oil well and directing into the separation chamber. The well fluid entering inlet 18 comes directly from the well head via flow line, or may have already been partially processed by other equipment, i.e., desander 10 may be one of many devices connected in series to process the fluid which might still have some spall. Those devices may for example include shakers (shale, rig, screen), separators, centrifuges, hydrocyclones, desilters, mud cleaners or conditioners, dryers, filtration units, settling beds, traps, storage tanks, mining floods, and the like. In the illustrative embodiment desander 10 is a production desander adapted for removing sand, silt, clay and other larger and smaller particulates, that is, particles having a size in the approximate range of 0.00079″ (20 microns) to in excess of 0.250″ (6350 microns), but those skilled in the art will appreciate that the present invention can be adapted for use with other particle sizes and accordingly placed at different locations along the fluid processing chain.

As explained further below, and similar to conventional hydrocyclone desanders, inlet 18 is tangentially disposed with regard to the generally circular cross-section of main body 12. In other words, it receives the fluid stream in an inlet direction generally perpendicular to a length direction of main body 12 and focuses the stream along an inner side wall of main body 12, so as the inner diameter of the inlet is flush with the inner diameter of the chamber 12 (the inlet direction does not have to be perfectly perpendicular to the main body). In the depicted embodiment this arrangement results in counterclockwise rotation of the fluid within main body 12 as seen from above but inlet 18 could of course be arranged along the other side to result in clockwise rotation of the fluid. In this manner, through the centrifugal action of the fluid as it rotates within main body 12, sand particles in the fluid are pushed outward and downward along the inside wall, allowing the production fluid to exit through a first outlet 20 in upper outlet cover 14 for further processing as desired. Sand collects at the bottom of main body 12 and when a substantial amount has accumulated it can be purged through a second outlet 22 in lower outlet cover 16 from whence it can be directed to other equipment as appropriate for cleaning and disposal.

Solids purging can be managed according to process design and budget. The most accepted process is to feel the temperature of the chamber 12, where there is a differentiation of temperature reveals where the solids top level has accumulated. An Emerson sand switch may be installed internal of chamber 12, an automated timer on the dump valve may be installed.

The dumping is then achieved via a manual or automated dump valve. The solids eject in the form of ‘wet solids’. This dump process is continued until wet fluids begin to flow. Then dump valve is immediately shut off in order to preserve process fluids.

There may be many variations of this basic design in different embodiments of the present invention; for instance, the inlet could be fashioned as part of the head (with upper outlet cover 14) instead of the main body. The interior space of main body 12 can also be a variety of shapes, e.g., cylindrical (tubular) or conical/frustoconical, tilted at any degree, and spherical. These vessels may also be horizontal, or a horizontal tilted at any degree in order to facilitate the required configuration for maximum process efficiency.

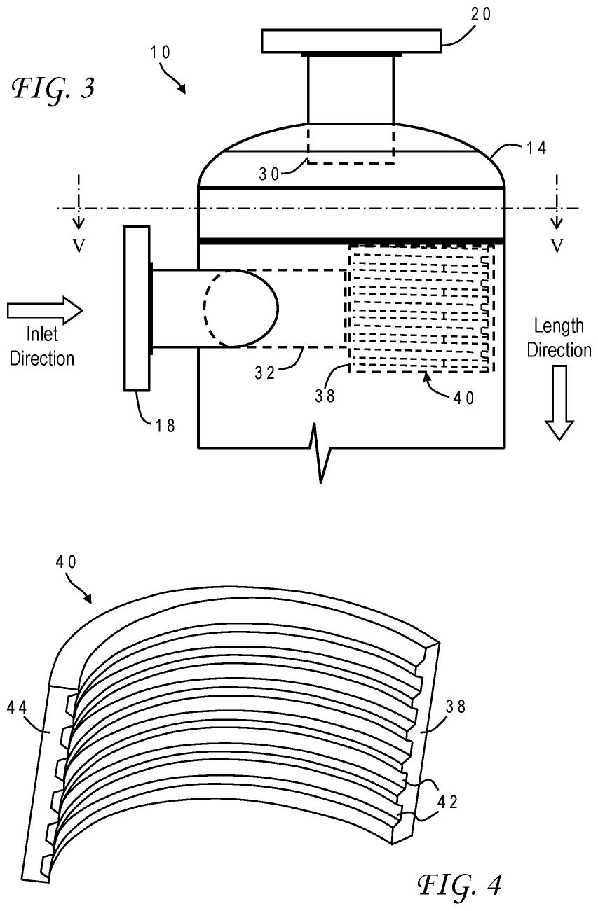

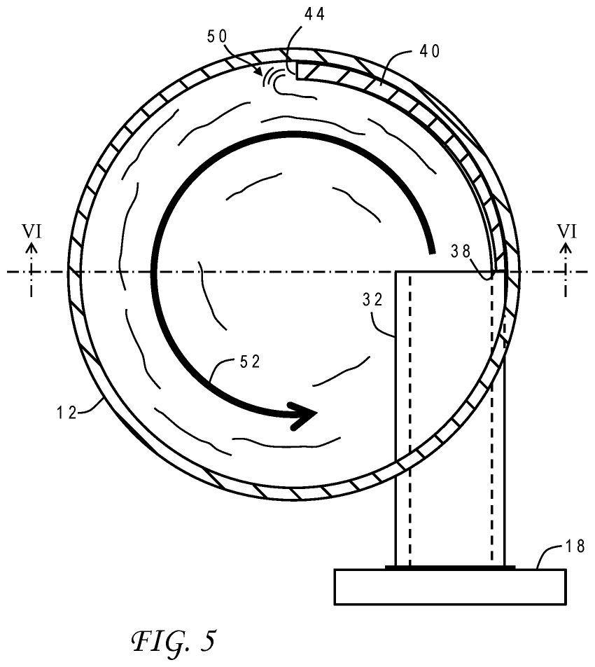

In the close-up view of FIG. 3 it can be seen that outlet 20 includes a pipe section 30 that extends into the central portion of upper outlet cover 14 and into the chamber of main body 12 to receive the higher pressure fluid at the center of the vortex. It can also be seen that inlet 18 includes a pipe section 32 that extends slightly into the interior of main body 12 to force the fluid stream in the tangential direction up to the exit point of pipe section 32. This exit point is immediately adjacent the leading edge 38 of a curved plate 40 shown separately in FIG. 4. Curved plate 40 is affixed to the inside of main body 12, and is positioned along one side of the interior such that the fluid stream is directed from pipe section 32 toward the concave surface of curved plate 40. In the exemplary embodiment the curvature of the plate is a generally circular arc, preferably around a quarter circle (about 90°) but it could be shortened or lengthened about an arc in order to maximize the efficiency of the separation process for a particular application. Arcs other than circular may be used, e.g., parabolic, hyperbolic or even irregular. The concave surface of curved plate 40 also preferably has grooves 42 formed therein which help further channel the fluid flow, maximize the vortex in a shorter interval along chamber 12, and increase vortex velocity; the grooves are most preferably helical in design, with a pitch inclined toward the bottom of main body 12.

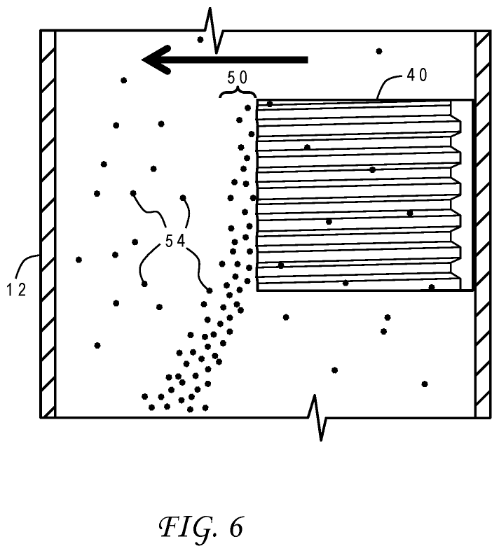

Referring now to FIG. 5, the previously mentioned counterclockwise movement of fluid within desander 10 is illustrated by the circular arrow 52. In this arrangement of curved plate 40 with respect to inlet 18, the trailing edge 44 of curved plate 40 creates a drop-off in the fluid flow causing an eddy region 50. This drop-off is preferably a 90° angle with respect to the concave surface along trailing edge 44, or it can be a negative angle depending upon application. A negative rake angle better facilitates the removal of sub-100 micron particles from flow rates that have at least a 70% or greater sub-140 micron particulate flow profile. Eddy region 50 contains a stagnant pressure zone that allows the suspended sand to more easily drop out of the higher velocity inlet flow profile. The peripheral flow is already at a lower pressure than the central area due to the vortex dynamics, so eddy region 50 further enhances removal of the sand to achieve a greatly improved efficiency. This increased sand density stemming from eddy region 50 is also seen in FIG. 6 where the dots 54 are generally representative of the relative sand density along this peripheral band of the fluid flow, i.e., adjacent the inner surface of main body 12. In other words, sand can more easily stay suspended in this region and then fall along the inside wall to the collection area at the bottom.

The components of desander 10, including main body 12, covers 14 and 16, inlet 18, outlets 20 and 22, and curved plate 40 can be constructed of any durable material such as a metal or metal alloy, particularly SA516 carbon steel. The grooves can be formed by internal threading of a section of pipe.

The specific dimensions of desander 10 may vary considerably depending upon the particular application. For an exemplary embodiment, the approximate dimensions are as follows. The length of vortex main body 12 is 120″, with inner and outer diameters of 12.75″ and 12″. Outlet covers 14 and 16 are approximately 6″ high. Inlet 18 and outlets 20, 22 have a diameter of 3″. Curved plate 40 has a maximum thickness of 1″ and a height of 12″. The grooves are 0.75″ deep with a trapezoidal profile and a spacing of 1″. The helical slant of the grooves is at 14.5°. It is preferable to use the largest grooves possible for a given plate thickness to minimize wear, create the stagnant pressure zone, and train the vortex. The helical grooved inlet plate greatly reduces abrasion by diverting the inlet fluid profile particulates along the sloped walls of the grooves, thereby dissipating the force of abrasion and capturing particles within the grooves. These dimensions are suitable for a desander having an expected average flow rate of 10,000 barrels/second at pressures around 300 psi, but as previously noted there could be many alternative sizes for other applications. For example, for flow rates less than 8,000 barrels per day, and less than 150 PSI, and through a 3″ flow line, the vortex plate is extended by 6″ in length, and the lower cover outlet is extended by 14″.

In this manner, various embodiments of the present invention provide superior removal of solids from flow profiles at both low and high pressures in post, and within, Oil & Gas production facilities. For flow profiles at low pressure (below 400 psi) particles are removed with a greater than 98% efficiency. Long-term use is not affected by highly corrosive gasses (sour gas, H₂S), preventing corrosive vessel deterioration. The exemplary implementations also do not allow abrasive corrosion during the inlet phase where solid particles usually erode the inner vessel wall and inlet piping. The illustrated design is also helpful in preventing scale compaction and crystallization in flow lines due to barite, calcite, aragonite, vaterite, anhydrite, gypsum, celestite, mackinawite, pyrite, halite and fluorite; these particles are removed from the flow profile and compacted into a scale within the inner surfaces of the vessel, preventing these damaging deposits from entering the outlet. Calcite is also removed from low pressure flow profiles where CO 2 depletion occurs. Importantly, the invention keeps fracking and formation particles from entering oil production equipment such as separators, heater treaters and fluid storage tanks which could lead to serious damage. The vessel produces the industry's ‘driest sand dump’: fracking sand, formation particles and solids are collected and dumped via a valve, in the form a wet-solid that is collected to evacuate the vessel with little to no flow profile fluids such as produced water and hydrocarbons that can be harmful to the environment, as well as cause a loss in production profits, giving this system a fully unique ability to retain fluid and evacuate solids. Fracking sand, formation particles and solids exit the vessel ‘clean’, as very little to no hydrocarbons adhere to solids evacuated from vessel, making the solids more suitable for non-contaminate disposal.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, the invention has been discussed in the context of removing sand from oil well production fluid (crude oil) but it could instead be used for drilling fluid reclamation. Of course there are other applications completely outside the oil field environment such as desalination. In systems with lower flow rates and fluid volumes the separator could be much smaller or much larger, such as water cooling systems and mining operations. The invention could also be adapted to separate liquids of different densities, i.e., not just solids. It is therefore contemplated that such modifications can be made without departing from the spirit or scope of the present invention as defined in the appended claims.

What is claimed is:

1. A vortex apparatus for separating solid particles from a fluid stream comprising:
an elongate hollow body having a first end, a second end, and an interior;
at least one inlet proximate said first end of said elongate hollow body for receiving the fluid stream in an inlet direction generally perpendicular to a length direction of said elongate hollow body, said inlet being positioned to direct the fluid stream along one side of said interior; and
a curved plate affixed to an inner surface of said elongate hollow body proximate said first end and positioned along said one side of said interior such that the fluid stream is directed from said inlet toward a concave surface of said curved plate.

2. The vortex apparatus of claim 1 further comprising:
at least a first outlet proximate said first end of said elongate hollow body, said first outlet having an entry port which extends into a circumferential central area of said interior;
at least a second outlet at said second end of said elongate hollow body for removing a buildup of the solid particles.

3. The vortex apparatus of claim 1 wherein the curved plate has a circular arc.

4. The vortex apparatus of claim 1 wherein said concave surface of said curved plate has a plurality of grooves formed therein.

5. The vortex apparatus of claim 4 wherein said grooves have a helical pitch inclined toward said second end of said elongate hollow body.

6. The vortex apparatus of claim 5 wherein a helical slant of said grooves is approximately 14.5°.

7. The vortex apparatus of claim 1 wherein:
said curved plate has a leading edge and a trailing edge; and
said inlet includes a pipe section extending into said interior of said elongate hollow body, said pipe section having an exit point immediately adjacent and on the same plane as said leading edge of said curved plate.

8. The vortex apparatus of claim 7 wherein said trailing edge creates a 90° drop-off in fluid flow.

9. A hydrocyclone desander comprising:
a generally cylindrical main body having an interior, a first end, a second end, and an inlet proximate said first end for receiving a fluid stream in an inlet direction generally perpendicular to a length direction of said main body, said inlet being tangentially positioned to direct the fluid stream along one side of said interior;
a first cover attached to said first end of said main body, said first cover having a first outlet with an entry port which extends into a circumferential central area of said interior proximate said first end of said main body;
a second cover attached to said second end of said main body, said second cover having a second outlet for removing a buildup of sand; and
a curved plate affixed to an inner surface of said main body proximate said first end and positioned along said one side of said interior such that the fluid stream is directed from said inlet toward a concave surface of said curved plate.

10. The hydrocyclone desander of claim 9 wherein the curved plate forms a circular arc.

11. The hydrocyclone desander of claim 10 wherein said concave surface of said curved plate has a plurality of grooves formed therein.

12. The hydrocyclone desander of claim 11 wherein said grooves have a helical pitch inclined toward said second end of said main body.

13. The hydrocyclone desander of claim 12 wherein a helical slant of said grooves is approximately 14.5°.

14. The hydrocyclone desander of claim 12 wherein:
said curved plate has a leading edge and a trailing edge; and
said inlet includes a pipe section extending into said interior of said main body, said pipe section having an exit point immediately adjacent said leading edge of said curved plate.

15. The hydrocyclone desander of claim 14 wherein said trailing edge creates a 90° drop-off with respect to said concave surface at said trailing edge.

16. In a hydrocyclone separator having an inlet which directs a fluid stream tangentially into a separation chamber, the improvement comprising:
a curved plate affixed to an inner surface of the separation chamber and positioned along one side of said separation chamber such that the fluid stream is directed from the inlet toward a concave surface of said curved plate.

17. The improvement of claim 16 wherein said curved plate has a circular arc in the range of 30° to 120°.

18. The improvement of claim 16 wherein said concave surface of said curved plate has a plurality of grooves formed therein.

19. The improvement of claim 18 wherein a helical slant of said grooves is approximately 14.5°.

20. The improvement of claim 16 wherein:
said curved plate has a leading edge and a trailing edge;
the inlet includes a pipe section extending into the separation chamber, the pipe section having an exit point immediately adjacent and on the same plane as said leading edge of said curved plate; and
said trailing edge creates a drop-off in fluid flow causing an eddy region.
